(19) United States
(12) Patent Application Publication
(10) Pub. No.: US 2024/0343238 A1
(43) Pub. Date: Oct. 17, 2024

(54) BRAKE SYSTEM FOR A MOTOR VEHICLE

(71) Applicant: Continental Automotive Technologies GmbH, Hannover (DE)

(72) Inventor: Aleksandar Stanojkovski, Kleinostheim (DE)

(73) Assignee: Continental Automotive Technologies GmbH, Hannover (DE)

(21) Appl. No.: 18/698,500

(22) PCT Filed: Sep. 29, 2022
(86) PCT No.: PCT/DE2022/200229

§ 371 Date: Apr. 4, 2024

(30) Foreign Application Priority Data
Oct. 7, 2021 (DE) 10 2021 211 321.4

(51) Int. Cl. B60T 13/68; B60T 7/04; B60T 13/66

(52) U.S. Cl. CPC B60T 13/686; B60T 7/042; B60T 13/662

(57) ABSTRACT

A brake system for a motor vehicleincludes a first unit, a second unit, and a pressure medium reservoir which is under atmospheric pressure. The first unit includes a first electrically actuable pressure supply device having a hydraulic pressure chamber, wherein the first electrically actuable pressure supply device is hydraulically connected to a first and a second output pressure port of the first unit, and wherein the second unit includes a first input port, which is hydraulically connected to at least one first wheel port of the second unit, a second input port, which is hydraulically connected to at least one second wheel port of the second unit, a second electrically actuable pressure supply device, which is hydraulically connected to the at least one first and the at least one second wheel port, and at least one inlet valve per first and second wheel port.

### CROSS-REFERENCE TO RELATED APPLICATIONS

This application is a national stage application, filed under 35 U.S.C. § 371, of International Patent Application No. PCT/DE2022/200229, filed on Sep. 29, 2022, which claims priority to German patent application No. 10 2021 211 321.4, filed on Oct. 7, 2021, each of which is incorporated by reference.

### TECHNICAL FIELD

The technical field relates to a brake system for a motor vehicle.

### BACKGROUND

DE 10 2018 222 478 A1 discloses a “brake-by-wire” brake system for motor vehicles, which comprises two units, wherein the first unit comprises a brake pedal-actuable master brake cylinder, a simulator, a first electrically controllable pressure supply device and two output ports, wherein the second unit is connected to the two output ports of the first unit and comprises a second electrically controllable pressure supply device in the form of two pumps and a pressure modulation unit for adjusting wheel-specific brake pressures, wherein the pressure modulation unit has one inlet valve and one outlet valve per wheel brake.

There remains an opportunity to provide a brake system which does not require a hydraulic driver fall-back level, to have the highest possible availability, while at the same time being cost-effective.

### SUMMARY

In one exemplary embodiment, a brake system includes a first unit, a second unit, and a pressure medium reservoir which is under atmospheric pressure. The first unit includes a first electrically actuable pressure supply device having a hydraulic pressure chamber, and a first and a second output pressure port. The first electrically actuable pressure supply device is hydraulically connected to the first and the second output pressure port. The second unit includes a first and a second input port and at least one first wheel port and at least one second wheel port, wherein the first input port is hydraulically connected to the at least one first wheel port, and the second input port is hydraulically connected to the at least one second wheel port. Furthermore, the second unit includes a second electrically actuable pressure supply device, which is hydraulically connected to the at least one first and the at least one second wheel port, and at least one inlet valve per first and second wheel port. The first output pressure port of the first unit is hydraulically connected to the first input port of the second unit, and the second output pressure port of the first unit is hydraulically connected to the second input port of the second unit.

The first unit does not include a further pressure supply device in addition to the first pressure supply device, and the pressure chamber of the first electrically actuable pressure supply device is hydraulically connected to the second output pressure port without connection of a valve in between.

The brake system as described above affords the advantage that it is particularly suitable for highly automated driving, since normal braking is possible even in the event of a failure of one of the pressure supply devices. The brake system can also be produced cost-effectively since it manages without a hydraulic driver fall-back level and requires relatively few valves. The brake system further affords the advantage that the two units can be arranged separately in the vehicle. Only two hydraulic connections between the first and second units are required.

In one embodiment, the pressure medium reservoir is arranged on the first unit to ensure a supply of the first pressure supply device.

The pressure chamber of the first electrically actuable pressure supply device may be hydraulically connected to the first output pressure port via an electrically actuable, normally open circuit isolating valve, wherein no further valve in addition to the circuit isolating valve is arranged in the hydraulic connection between the pressure chamber and the first output pressure port. The circuit isolating valve can be used to hydraulically separate the first output pressure port from the second output pressure port, e.g., in the event of a leakage. For example, a hydraulic circuit separation is possible.

In one embodiment, the first output pressure port is hydraulically connected to the pressure medium reservoir via a first electrically actuable isolating valve. The first output pressure port can thus be switched in a pressure-free manner. Particularly, the first isolating valve is normally open. As a result, the first output pressure port, and thus the wheel port(s) connected to it, are switched in a pressure-free manner when the brake system is in the deenergized state.

In one embodiment, the pressure chamber of the first electrically actuable pressure supply device and the second output port are hydraulically connected to the pressure medium reservoir via a second electrically actuable isolating valve. No further valve in addition to the second isolating valve is arranged in said hydraulic connection between the pressure chamber and the second output pressure port, on the one hand, and the pressure medium reservoir, on the other hand. The second output pressure port can thus be switched in a pressure-free manner. The second isolating valve also makes it possible to ensure that the second unit, even in the event of circuit separation by the circuit isolating valve, can suck pressure medium volume out of the pressure medium reservoir in said (second) brake circuit, but can also deliver same to the pressure medium reservoir. Particularly, the second isolating valve is normally open. As a result, the second output pressure port, and thus the wheel port(s) connected to it, are switched in a pressure-free manner when the brake system is in the deenergized state. The pressure chamber of the first electrically actuable pressure supply device may be additionally hydraulically connected to the pressure medium reservoir via a non-return valve closing in the direction of the pressure medium reservoir.

According to one embodiment, the second unit includes a first brake circuit, which hydraulically connects the first input port to the at least one first wheel port, and a second brake circuit, which hydraulically connects the second input port to the at least one second wheel port. The second electrically actuable pressure supply device includes one pump per brake circuit, one outlet valve is provided per first and second wheel port, and one low-pressure accumulator per brake circuit, which is connected to the output ports of the outlet valves assigned to the brake circuit. Such a module is basically in the form of an ESC brake module (ESC: Electronic Stability Control) has been known for many years and can therefore be produced cost-effectively.

For pressure control circuit by circuit, a first pressure sensor for the first input port and a second pressure sensor for the second input port may be provided in the second unit.

According to one embodiment of the brake system, the first unit and the second unit each include a separate electronic open-loop and closed-loop control unit. This advantageously ensures independent control of the first and second electrically controllable pressure supply devices.

The brake system may also include a first electronic open-loop and closed-loop control unit and a second electronic open-loop and closed-loop control unit. The first electronic open-loop and closed-loop control unit is electrically independent of the second electronic open-loop and closed-loop control unit. The first electronic open-loop and closed-loop control unit controls the electrically actuable components of the first unit, in particular the first pressure supply device.

In one embodiment, the second electronic open-loop and closed-loop control unit controls the electrically actuable components of the second unit, in particular the second pressure supply device. Thus, in the event of failure of one of the open-loop and closed-loop control units, the other open-loop and closed-loop control unit, with the pressure supply device controlled by it, can carry out an active build-up of pressure at all of the wheel brakes.

In one embodiment, the first and the second pressure sensor of the second unit are connected in terms of signaling to the second electronic open-loop and closed-loop control unit. The pressure signals of the first and the second pressure sensor are particularly preferably transmitted by means of a communication device (e.g. data bus) from the second electronic open-loop and closed-loop control unit to the first electronic open-loop and closed-loop control unit.

In one emdobiment, the brake system includes a brake pedal unit, which is connected only electrically to the first and second unit. This means that the brake pedal unit is not hydraulically connected to the hydraulic units of the brake system. The brake system does not have a hydraulic fall-back level.

In one embodiment, a driver's brake request is generated in the brake pedal unit and forwarded to the electronic open-loop and closed-loop control units of the first and second units (e.g., via CAN, FlexRay, etc.). Alternatively, only one brake pedal movement is forwarded to at least one of the two electronic open-loop and closed-loop control units and to generate a driver's brake request in the corresponding open-loop and closed-loop control units.

In one emdobiment, the first pressure supply device is in the form of a cylinder-piston arrangement, the piston of which delimits the hydraulic pressure chamber and can be advanced and retracted by an electromechanical actuator.

The second pressure supply device may be formed by two pumps jointly driven by an electric motor.

In one embodiment, the first wheel ports are assigned to wheel brakes of a rear axle and the second wheel ports are assigned to wheel brakes of a front axle. Thus, in particular for regenerative braking, the first pressure supply device can apply pressure to the front axle wheel brakes and the second pressure supply device can apply pressure to the rear axle wheel brakes.

### DETAILED DESCRIPTION OF THE DRAWINGS

Further embodiments of the disclosure may be apparent from the claims and the description below with reference to a figure,

in which, schematically:

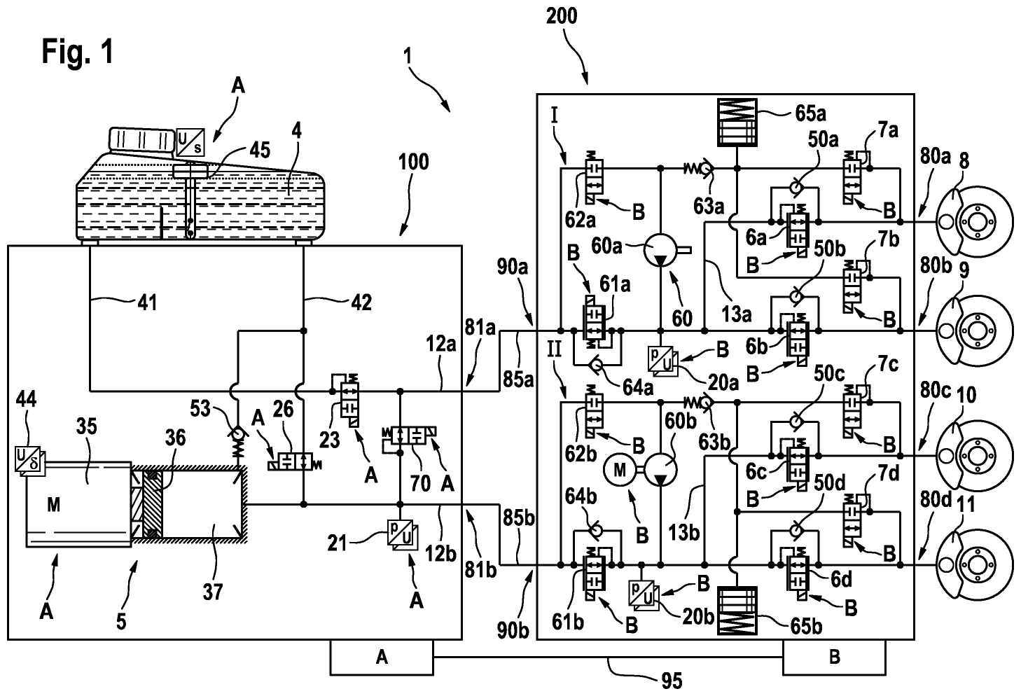

FIG. 1 shows an exemplary embodiment of a brake system according to one embodiment.

### DETAILED DESCRIPTION

FIG. 1 schematically illustrates an exemplary embodiment of a brake system for a motor vehicle with four wheels. The brake system includes a first unit or a first independent module 100, also called pressure supply module, a second unit or a second independent module 200, also called wheel pressure supply module, and a pressure medium reservoir 4, which is under atmospheric pressure. The first and second unit or module are structurally separate and can be arranged, e.g., separately, in the motor vehicle. The pressure medium reservoir 4 is assigned to the first unit and arranged thereon.

The first unit 100 includes a first electrically actuable pressure supply device 5 with a pressure chamber 37, a first output pressure port 81a, and a second output pressure port 81b, wherein the first pressure supply device 5 is hydraulically connected to the first and the second output pressure port 81a, 81b. The first unit 100 does not include any further pressure supply device other than the pressure supply device 5, i.e., neither a brake pedal-actuable pressure source or pressure supply device, such as a brake pedal-actuated master brake cylinder, nor another electrically actuable pressure source or pressure supply device. The pressure chamber 37 of the first pressure supply device 5 is hydraulically connected to the second output pressure port 81b without connection of a valve in between, e.g., a non-return valve or an electrically/hydraulically/mechanically actuable switching valve. For this purpose, the pressure chamber 37 is hydraulically connected to the second output pressure port 81b via a brake circuit pressure line section 12b, which is formed in the first unit and in which no valve is arranged. Advantageously, no other hydraulic component, such as a separating piston device, is arranged in the hydraulic connection 12b between pressure chamber 37 and output pressure port 81b. In this context, the pressure chamber 37 is hydraulically connected directly to the output pressure port 81b.

The second unit 200 comprises a first input port 90a, a second input port 90b and a wheel port 80a, 80b, 80c, 80d for each of the four hydraulically actuable wheel brakes 8, 9, 10, 11 of the motor vehicle.

The input port 90a is hydraulically connected to the two (first) wheel ports 80a, 80b and the input port 90b is hydraulically connected to the two (second) wheel ports 80c, 80d. Furthermore, the second unit 200 includes a second electrically actuable pressure supply device 60 for the electrically controlled supply of a brake pressure, which is hydraulically connected to each of the wheel ports 80a, 80b, 80c, 80d, and at least one inlet valve 6a, 6b, 6c, 6d per wheel port 80a, 80b, 80c, 80d for adjusting wheel-specific wheel brake pressures. As an example, the second unit 200 comprises an inlet valve 6a, 6b, 6c, 6d and an outlet valve 7a, 7b, 7c, 7d per wheel port 80a, 80b, 80c, 80d.

The second unit 200 is hydraulically connected downstream of the first unit 100. For this purpose, the first output pressure port 81a of the first unit 100 is connected to the first input port 90a of the second unit 200 and the second output pressure port 81b of the first unit 100 is connected to the second input port 90b of the second unit 200.

First and second unit/first and second module 100, 200 are connected to each other by only two hydraulic connecting lines 85a, 85b, which respectively hydraulically connect the output pressure port 81a, 81b of the first unit 100 to the associated input port 90a, 90b of the second unit 200.

In the unit 100, the pressure chamber 37 of the first electrically actuable pressure supply device 5 is hydraulically connected to the second output pressure port 81b via the brake circuit pressure line section 12b, without a valve being connected in between. The pressure chamber 37 is hydraulically connected to the first output pressure port 81a via an electrically actuable circuit isolating valve 70. For this purpose, the brake circuit pressure line section 12b is connected via the circuit isolating valve 70 to a brake circuit pressure line section 12a, which leads to the first output pressure port 81a. The brake circuit pressure line section 12a and the brake circuit pressure line section 12b are thus hydraulically connected to each other via the circuit isolating valve 70. The circuit isolating valve 70 is designed as a normally open valve, e.g. 2/2-way valve.

Only the circuit isolating valve, and no other valve, i.e., no non-return valve and no electrically/hydraulically/mechanically actuable switching valve, is arranged in the hydraulic connection between pressure chamber 37 and the first output pressure port 81a. Advantageously, no other hydraulic component, such as a separating piston device, is arranged in the hydraulic connection between pressure chamber 37 and first output pressure port 81a.

When the circuit isolating valve 70 is open, upon displacement of the piston 36 in the brake actuation direction, pressure medium passes out of the pressure chamber 37 into the brake circuit pressure line sections 12b and 12a, and therefore into the wheel pressure supply module 200, and thus into the wheel brakes 8, 9, 10, 11 for their actuation.

Pressure supply device 5 is accordingly hydraulically connected via the circuit isolating valve 70 to the second brake circuit pressure line section 12b, and therefore directly to the second output pressure port 81b, and to the first brake circuit pressure line section 12a, and therefore to the first output pressure port 81a.

The first output pressure port 81a is hydraulically connected to the pressure medium reservoir 4 via an electrically actuable (first) isolating valve 23. For this purpose, the brake circuit pressure line section 12a is connected via the first isolating valve 23 by a (first) hydraulic connecting line 41 to the pressure medium reservoir 4.

For example, only the first isolating valve 23, and no other valve, i.e., no non-return valve and no electrically/hydraulically/mechanically actuable switching valve, is arranged in the hydraulic connection 12a, 41 between the first output pressure port 81a and the pressure medium reservoir 4. Advantageously, no other hydraulic component, such as a separating piston device, is arranged in the hydraulic connection 12a, 41 between the first output pressure port 81a and the pressure medium reservoir 4. The hydraulic connection 41 between the first isolating valve 23 and the pressure medium reservoir 4 is direct in the sense that it does not pass through another hydraulic component, such as a master brake cylinder or a pressure supply device or a valve.

The first isolating valve 23 is advantageously designed as a normally open valve, e.g., 2/2-way valve.

The pressure chamber 37 of the first electrically actuable pressure supply device 5 and the second output port 81b are hydraulically connected to the pressure medium reservoir 4 via an electrically actuable (second) isolating valve 26. For this purpose, for example, the second brake circuit pressure line section 12b, and thus the pressure chamber 37 and the second output port 81b, are connected via the second isolating valve 26 by a (second) hydraulic connecting line 42 to the pressure medium reservoir 4.

For example, only the second isolating valve 26 is arranged in the hydraulic connection 12b, 42 between pressure chamber 37 and pressure medium reservoir 4; no further valve is connected in series. Advantageously, also no other hydraulic component, such as a separating piston device, is arranged in the hydraulic connection 12b, 42 between pressure chamber 37 and pressure medium reservoir 4. The hydraulic connection 42 between the second isolating valve 26 and the pressure medium reservoir 4 is direct in the sense that it does not pass through another hydraulic component, such as a master brake cylinder or a pressure supply device or a valve.

The second isolating valve 26 is advantageously designed as a normally open valve, e.g., 2/2-way valve.

The pressure chamber 37 of the first electrically actuable pressure supply device 5 is additionally hydraulically connected to the pressure medium supply reservoir 4 via a non-return valve 53 closing in the direction of the pressure medium reservoir 4. For this purpose, for example, the pressure chamber 37 is connected via the non-return valve 53 by the (second) hydraulic connecting line 42 to the pressure medium reservoir 4. Pressure chamber 37 is thus connected to the pressure medium reservoir 4 via a parallel connection of the second isolating valve 26 and non-return valve 53.

For detecting the pressure of the first pressure supply device 5, a, redundantly designed, pressure sensor 21 may be provided in the first unit 100, which is connected, for example, to the second brake circuit pressure line section 12b.

The first electrically controllable pressure supply device 5 is advantageously in the form of a hydraulic cylinder-piston arrangement with the hydraulic pressure chamber 37, the piston 36 of which can be displaced forward and backward by an electromechanical actuator. Pressure supply device 5 thus represents a single-circuit electro-hydraulic actuator, the piston 36 of which, which delimits the pressure chamber 37, can be displaced forward and backward by a schematically indicated electric motor 35 with a likewise schematically illustrated rotary translation gear connected in between. A schematically indicated rotor position sensor serving to detect the rotor position of the electric motor 35 is denoted by the reference sign 44.

As an example, the first pressure supply device 5, the circuit isolating valve 70, the first isolating valve 23, and the second isolating valve 26 are arranged in the first independent unit (circuit pressure supply module) 100. The non-return valve 51 and the sensors 21 and 44 are also arranged in the module 100.

To control the electrically actuable components 35, 70, 23, 26 of the unit 100, the unit 100 may include a first electronic open-loop and closed-loop control unit (ECU) A.

The second unit or the wheel pressure supply module 200 is constructed in two circuits, wherein the first brake circuit I hydraulically connects the first input port 90a to the two first wheel ports 80a, 80b, and the second brake circuit II hydraulically connects the second input port 90b to the two second wheel ports 80c, 80d. The second electrically actuable pressure supply device 60 includes one pump 60a, 60b per brake circuit I, II, by means of which a brake pressure can be built up in an electrically controlled manner in the brake circuits I, II and thus in the wheel brakes 8, 9, 10, 11.

The first input port 90a is connected via a hydraulic connection 13a to the inlet valves 6a, 6b of the first wheel ports 80a, 80b. The second input port 90b is connected via a hydraulic connection 13b to the inlet valves 6c, 6d of the second wheel ports 80c, 80d.

For each brake circuit I, II, a low-pressure accumulator 65a or 65b is present, which is connected to the output ports of the outlet valves 7a, 7b or 7c, 7d assigned to the brake circuit I or II. Thus, pressure medium from the wheel brakes 8, 9, 10, 11 can be discharged into the low-pressure accumulators 65a, 65b, e.g. in the case of an ABS control system (anti-lock control).

The wheel pressure supply module 200 is designed, for example, as an ESC (ESC: Electronic Stability Control) module which is known per se and which will be described in more detail below.

Inlet and outlet valves 6a-6d, 7a-7d are hydraulically connected in pairs by central ports and connected to the respective wheel brake 8, 9, 10, 11.

The input ports of the inlet valves 6a, 6b or 6c, 6d of a brake circuit I or II are connected via a modulator pre-pressure line 13a or 13b and an analogously controllable, normally open valve 61a or 61b, to which a non-return valve 64a or 64b opening in the flow direction to the wheel brakes is connected in parallel, to the associated input port 90a or 90b of the unit 200. A non-return valve 50a-50d opening toward the modulator pre-pressure lines 13a, 13b is in each case connected in parallel to the inlet valves 6a-6d.

The output ports of the outlet valves 7a, 7b or 7c, 7d of a brake circuit I or II are connected to a hydraulic low-pressure accumulator 65a, 65b.

The second pressure supply device 60 includes two pumps 60a, 60b, which are driven by a common electric motor M. Each pump 60a or 60b is assigned to one of the brake circuits I or II. The pressure side of the pump 60a or 60b is connected to the corresponding modulator pre-pressure line 13a or 13b, and thus to the inlet valves of the corresponding brake circuit. The suction side of the pump 60a or 60b is connected, on the one hand, to the corresponding low-pressure accumulator 65a or 65b of the brake circuit I or II via a non-return valve 63a or 63b closing in the direction of the low-pressure accumulator. On the other hand, the suction side of the pump 60a or 60b is connected to the corresponding input port 90a or 90b via an electrically actuable, advantageously normally closed, pressure medium supply valve 62a or 62b.

To detect the pressures prevailing in the brake circuits I, II of the second unit 200, a pressure sensor 20a or 20b, preferably redundantly designed, is in each case connected to the modulator pre-pressure line 13a or 13b.

To control the electrically actuable components 60, 6a-6d, 7a-7d, 61a, 62a, 61b, 62b of the unit 200, the unit 200 may include a second electronic open-loop and closed-loop control unit (ECU) B.

As an example, the first and the second pressure sensor 20a, 20b of the second unit 200 are connected in terms of signaling to the second electronic open-loop and closed-loop control unit B. The signals from the pressure sensors 20a, 20b are fed to the second electronic open-loop and closed-loop control unit B and evaluated there.

The first electronic open-loop and closed-loop control unit A and the second electronic open-loop and closed-loop control unit B are electrically independent of each other, in the sense that an electrical fault in one of the open-loop and closed-loop control units does not lead to a failure of the other open-loop and closed-loop control unit. The electronic open-loop and closed-loop control units A, B are advantageously connected to each other with a communication device 95 (e.g., data bus) in order to be able to exchange data.

For normal braking utilizing the first pressure supply device 5 (preferred normal operating mode), the first and the second isolating valves 23, 26 are closed and the first pressure supply device 5 builds up brake pressure at the wheel brakes 8-11 of the two brake circuits I, II.

For a normal braking utilizing the second pressure supply device 60, for example in the event of a failure of the first pressure supply device 5 or the first electronic open-loop and closed-loop control unit A, the valves 61a and 61b are closed and the valves 62a, b are open. A brake pressure is built up by means of the second pressure supply device 60 in the two brake circuits I, II.

A wheel pressure control is possible with the inlet and outlet valves 6a-6d, 7a-7d by the second electronic open-loop and closed-loop control unit B.

The second unit 200 can ensure a high ASIL level by utilizing the pressure sensors 20a, 20b.

Excess pressure medium volume can be pumped as required by means of the second pressure supply device 60 via the valves 61a and 61b into the pressure medium reservoir 4.

For example, if a leakage is detected, the brake circuits I, II can be isolated by closing of the circuit isolating valve 70. The first pressure supply device 5 can then build up pressure in the brake circuit II with the isolating valve 26 closed, or the second pressure supply device 60 can build up pressure in the other brake circuit I with the valve 61a closed and the valve 62a open.

For example, in the case of the double error of a leakage and a failure of the first pressure supply device 5, the circuit isolating valve 70 and the valves 61a and 61b can be closed and the valves 62a and 62b opened, the second pressure supply device 60 can thus build up pressure in the two brake circuits I, II, with the two suction paths from the pressure medium reservoir 4 remaining hydraulically separated.

If the first wheel ports 80a, 80b are assigned to the wheel brakes 8, 9 of a rear axle and the second wheel ports 80c, 80d to the wheel brakes 10, 11 of a front axle, a two-channel ABS can be implemented. For example, for regenerative braking, the first pressure supply device 5 with closed isolating valves 23, 26 and closed valve 61a can apply pressure to the front axle wheel brakes 10, 11 and control the pressure, while the second pressure supply device 60 applies pressure to the rear axle wheel brakes 8, 9.

If the first pressure supply device 5 cannot apply enough pressure medium volume to build up a wheel pressure, the second pressure supply device 60 can be used for support. When isolating valves 23, 26 are closed, the pre-pressure of the first pressure supply device 5 in the wheel brakes 8-11 can be reinforced by the second pressure supply device 60.

For suction of pressure medium out of the pressure medium reservoir 4 with the first pressure supply device 5, the valves 61a, 61b are closed to hold the pressure in the brake circuits I, II, and the piston 36 of the pressure supply device 5 is retracted to suck pressure medium into the pressure chamber 37 via the open isolating valve 26.

In the event of a failure of the second unit 200, it is possible with the first unit 100 (especially the first pressure supply device 5 and the circuit isolating valve 70) to present an electronic (axle) braking force distribution (distribution of the brake pressure only between the front and rear axle). In this case, a black-and-white distribution of the wheel brakes to the brake circuits I, II should be present and the pressure supply device 5 should be assigned to the front axle. The pressure supply device 5 could thus modulate the pressure on both axles. By closing of the circuit isolating valve 70, pressure on the rear axle can be maintained, while the pressure supply device 5 further modulates the brake pressure on the front axle.

The exemplary brake system affords the following advantages:
hydraulic circuit isolation is possible by the circuit isolating valve 70.
Since both electronic open-loop and closed-loop control units can provide brake pressure, there is redundancy for electrical faults.
If the first pressure supply device 5 fails (e.g., due to leakage, electrical or mechanical faults), this has no effect on the pressure build-up by the second pressure supply device 60. In each case of fault, the second pressure supply device 60 can suck up pressure medium volume from the pressure medium reservoir or return same again to it.
An ESC module which is known per se can be used as a second unit 200 without any new or further development.
Unit 100 manages with three electrically actuable valves 23, 26, 70.
The first pressure supply device 5 of the first unit 100 may be smaller in size, since it can be supported by the second pressure supply device 60 of the second unit.
Only 2 brake lines are required between the unit 100 and the unit 200.
The brake system has full redundancy for normal braking (i.e., braking of all of the wheel brakes 8-11 without wheel-specific pressure control) (in relation to mechanical or electrical faults or leakages).

1-10. (canceled)

11. A brake system for a motor vehicle, comprising:
a first unit including a first electrically actuable pressure supply device having a hydraulic pressure chamber, wherein the first electrically actuable pressure supply device is hydraulically connected to a first output pressure port and a second output pressure port;
a second unit including
a first input port which is hydraulically connected to at least one first wheel port,
a second input port which is hydraulically connected to at least one second wheel port,
a second electrically actuable pressure supply device hydraulically connected to the at least one first wheel port and the at least one second wheel port, and
at least one inlet valve per first and second wheel port;
wherein the first output pressure port of the first unit is connected to the first input port of the second unit and the second output pressure port of the first unit is connected to the second input port of the second unit; and
a pressure medium reservoir which is under atmospheric pressure;
wherein the first electrically actuable pressure supply device is the only pressure supply device associated with the first unit; and
wherein the first electrically actuable pressure supply device is hydraulically connected to the second output pressure port without connection of a valve in between.

12. The brake system as set forth in claim 11, wherein the pressure chamber of the first electrically actuable pressure supply device is hydraulically connected to the first output pressure port via an electrically actuable, normally open circuit isolating valve, and wherein no further valve in addition to the circuit isolating valve is arranged in the hydraulic connection between the pressure chamber and the first output pressure port.

13. The brake system as set forth in claim 11, wherein the first output pressure port is hydraulically connected to the pressure medium reservoir via a first electrically actuable isolating valve.

14. The brake system as set forth in claim 11, wherein the pressure chamber of the first electrically actuable pressure supply device and the second output port are hydraulically connected to the pressure medium reservoir via a second electrically actuable isolating valve, wherein no further valve in addition to the second isolating valve is arranged in said hydraulic connection between the pressure chamber and both the second output pressure port and the pressure medium reservoir.

15. The brake system as set forth in claim 14, wherein the second electrically actuable isolating valve is normally open.

16. The brake system as set forth in claim 15, wherein the pressure chamber of the first electrically actuable pressure supply device is additionally hydraulically connected to the pressure medium reservoir via a non-return valve closing in the direction of the pressure medium reservoir.

17. The brake system as set forth in claim 11, wherein the second unit includes:
a first brake circuit which hydraulically connects the first input port to the at least one first wheel port; and
a second brake circuit which hydraulically connects the second input port to the at least one second wheel port;
wherein the second electrically actuable pressure supply device includes one pump per brake circuit;
one outlet valve is provided per first and second wheel port; and
one low-pressure accumulator is provided per brake circuit, said low-pressure accumulator is connected to output ports of the outlet valves assigned to the brake circuit.

18. The brake system as set forth in claim 11, wherein the second unit further includes a first pressure sensor for the first input port and a second pressure sensor for the second input port.

19. The brake system as set forth in claim 18, further comprising a first electronic open-loop and closed-loop control unit and a second electronic open-loop and closed-loop control unit, wherein the first electronic open-loop and closed-loop control unit is electrically independent of the second electronic open-loop and closed-loop control unit, and wherein the first electronic open-loop and closed-loop control unit controls the electrically actuable components of the first unit, wherein the second electronic open-loop and closed-loop control unit controls the electrically actuable components of the second unit, and wherein the first and the second pressure sensor of the second unit are connected in terms of signaling to the second electronic open-loop and closed-loop control unit.

20. The brake system as set forth in claim 11, further comprising a brake pedal unit connected only electrically to the first and second unit.
